(19) United States
(12) Patent Application Publication
(10) Pub. No.: US 2026/0349865 A1
(43) Pub. Date: Nov. 5, 2026

(54) CONTEXT-DRIVEN ERROR DIAGNOSIS AND MITIGATION FOR CLOUD SERVICES

(71) Applicant: International Business Machines Corporation, Armonk, NY (US)

(72) Inventors: Kevin ZHANG, Durham, NC (US); Brian William SVIHOVEC, Cary, NC (US); Jonathan Francis WOODLIEF, Raleigh, NC (US); Gili MENDEL, Cary, NC (US)

(21) Appl. No.: 19/195,727

(22) Filed: Apr. 30, 2025

(51) Int. Cl. G06F 11/07

(52) U.S. Cl. CPC G06F 11/079; G06F 11/0709; G06F 11/0793

(57) ABSTRACT

Context data is obtained from multiple data sources based on a transaction identifier associated with an error indication corresponding to an error in a cloud-based service. A set of error symptoms associated with the error is created based on the context data. Context output is created based on the context data and the set of error symptoms. A retrieval-augmented generation (100RAG) prompt is created for a machine learning component. The RAG prompt is output to the machine learning component to cause it to produce machine learning output indicative of a mitigation instruction associated with the error.

### BACKGROUND

The present invention relates to cloud services, and for example, relates to context-driven error diagnosis and mitigation for cloud services.

### SUMMARY

In one embodiment, a computer-implemented method is provided. In this embodiment, the method includes obtaining, based on a transaction identifier (ID) associated with an error indication corresponding to an error associated with at least one cloud-based service, context data from a plurality of data sources. The method further includes creating, based on the context data, a set of error symptoms associated with the error, creating context output based on the context data and the set of error symptoms, creating a retrieval-augmented generation (RAG) prompt for a machine learning component, and outputting the RAG prompt to the machine learning component to cause the machine learning component to produce machine learning output indicative of a mitigation instruction associated with the error.

In some implementations, a computer program product is provided. In this implementation, the computer program product includes one or more computer-readable storage media and program instructions stored on the one or more computer-readable storage media to perform operations. The operations include obtaining, based on a transaction identifier (ID) associated with an error indication corresponding to an error associated with at least one cloud-based service, context data from a plurality of data sources. The operations further include creating, based on the context data, a set of error symptoms associated with the error, creating context output based on the context data and the set of error symptoms, creating a retrieval-augmented generation (RAG) prompt for a machine learning component, and outputting the RAG prompt to the machine learning component to cause the machine learning component to produce machine learning output indicative of a mitigation instruction associated with the error.

In some implementations, a computer system is provided. In this implementation, the computer system includes a processor set, one or more computer-readable storage media, and program instructions stored on the one or more computer-readable storage media to cause the processor set to perform operations. The operations include obtaining, based on a transaction identifier (ID) associated with an error indication corresponding to an error associated with at least one cloud-based service, context data from a plurality of data sources. The operations further include creating, based on the context data, a set of error symptoms associated with the error, creating context output based on the context data and the set of error symptoms, creating a retrieval-augmented generation (RAG) prompt for a machine learning component, and outputting the RAG prompt to the machine learning component to cause the machine learning component to produce machine learning output indicative of a mitigation instruction associated with the error.

### BRIEF DESCRIPTION OF THE DRAWINGS

FIG. 1A is a block diagram of an example computing system described herein.

FIG. 1B is a block diagram of an example of a computing environment implemented using the computing system of FIG. 1A.

FIGS. 1C-1E are schematic diagrams associated with context-driven error diagnosis and mitigation for cloud services, implemented using the computing system of FIG. 1A.

FIG. 2 is a flow diagram showing an example of a process associated with context-driven error diagnosis and mitigation for cloud services.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with context-driven error diagnosis and mitigation for cloud services described herein.

### DETAILED DESCRIPTION

The following detailed description of example implementations refers to the accompanying drawings. The same reference numbers in different drawings may identify the same or similar elements.

Cloud computing environments have become increasingly complex, often involving numerous interconnected microservices and distributed systems. These environments present challenges in diagnosing and resolving errors that can occur across multiple services. Traditional error logging and debugging techniques struggle to provide a comprehensive view of system-wide issues, particularly when errors propagate through multiple dependent services. The distributed nature of cloud-based systems makes it difficult to trace the root cause of errors and understand their full impact across the entire ecosystem.

One of the technical challenges in diagnosing errors in cloud environments is the vast amount of log data generated by multiple services. This data is often fragmented across different systems, making it challenging to correlate relevant information and identify the source of an error. Additionally, the dynamic nature of cloud environments, with frequent code updates and configuration changes, further complicates the process of pinpointing the cause of errors. Current error diagnosis tools often lack the capability to efficiently analyze and synthesize information from diverse sources such as application logs, code repositories, and incident management systems.

Another technical issue is the complexity of interpreting error data in the context of interdependent microservices. When an error occurs in one service, it can have cascading effects on other dependent services, making it difficult to determine the original source of the problem. This complexity is compounded by the fact that different services may be managed by separate teams, each using their own set of tools and practices for error logging and management. The lack of a unified approach to error analysis across services hinders the ability to quickly identify and resolve system-wide issues.

Furthermore, the sheer scale of modern cloud environments poses challenges for timely error resolution. With potentially thousands of services running simultaneously, manually analyzing error logs and tracing error propagation becomes impractical and time-consuming. This delay in identifying and addressing errors can lead to prolonged system downtime, degraded performance, and negative impacts on user experience. The need for rapid, automated error diagnosis and mitigation strategies has become important in maintaining the reliability and efficiency of cloud-based systems.

Implementations of this disclosure address problems such as these by obtaining context data from multiple data sources based on a transaction identifier associated with an error in a cloud-based service, creating a set of error symptoms from the context data, generating context output, creating a retrieval-augmented generation (RAG) prompt for a machine learning component, and outputting the RAG prompt to produce machine learning output indicating mitigation instructions for the error. This technical solution improves upon traditional error diagnosis methods by automating the collection and analysis of relevant data across distributed systems, enabling faster and more accurate identification of error sources.

In some implementations, the context data may be obtained by tracing transactions across multiple services using the transaction identifier. For example, if an error occurs in a billing service, the system may trace related transactions through authentication, inventory, and shipping services to gather comprehensive context. The term “transaction identifier” refers to a unique code or tag associated with a specific operation or set of operations within the cloud environment. In some implementations, other correlation mechanisms such as time-based grouping or service-specific identifiers may be used to associate related events across services.

The creation of error symptoms involves translating raw context data into a more concise and structured format. This process may include extracting information from running application logs, code repositories, and configuration changes. For instance, a large volume of log data may be distilled into a symptom like “500 authentication errors in US-East region within 5 minutes.” The term “error symptoms” encompasses these abstracted representations of system behavior indicative of a problem. In some implementations, the set of error symptoms may have a significantly smaller data volume compared to the raw context data, improving processing efficiency.

Context output is generated based on both the raw context data and the derived error symptoms. This output may be prioritized using various ranking factors such as temporal proximity to the incident, error severity, service interdependencies, historical patterns, and recent code changes. For example, logs from services directly involved in the error may be ranked higher than those from tangentially related services. The term “ranking factor” refers to any criterion used to assess the relevance or importance of a piece of context information. In some implementations, machine learning techniques may be used to dynamically adjust ranking factors based on their effectiveness in previous error diagnoses.

The system creates a RAG prompt, which combines the context output with a query structure suitable for input to a machine learning component. In some implementations, this machine learning component may be a large language model (LLM). The term “RAG prompt” refers to a specially formatted input that provides both a query and relevant contextual information to guide the machine learning component's response. For example, a RAG prompt might include the error symptoms, recent code changes, and a request to diagnose the root cause of the error.

Upon receiving the machine learning output, the system may take various actions to address the identified error. In some implementations, this may involve sending notifications through a notification engine, such as alerts to system administrators or affected users. In some implementations, the system may initiate automated mitigation operations through a mitigation engine, such as rolling back recent changes or isolating problematic services. The term “mitigation instruction” encompasses any actionable guidance for resolving or reducing the impact of the detected error.

This disclosure provides a technical improvement over existing error diagnosis systems by leveraging machine learning and automated context gathering to rapidly identify and address issues in complex cloud environments. By distilling vast amounts of distributed data into relevant symptoms and context, the system enables more efficient and accurate error resolution, potentially reducing system downtime and improving overall service reliability. In some implementations, feedback mechanisms may be incorporated to continuously improve the accuracy of error diagnosis and mitigation strategies over time.

In some implementations, the system obtains context data from multiple data sources based on a transaction identifier associated with an error in a cloud-based service. Accordingly, an advantage of obtaining context data from multiple sources is a more comprehensive view of the error across interconnected microservices. Additionally, an advantage of using a transaction identifier is the ability to trace related events through various dependent services, providing a cohesive picture of the error's propagation. Furthermore, an advantage of this approach is the reduction in manual effort required to collect and correlate data from disparate systems, enabling faster initial error assessment.

In some implementations, the system creates a set of error symptoms by translating raw context data into a more concise and structured format. Accordingly, an advantage of creating error symptoms is the significant reduction in data volume compared to raw logs, improving processing efficiency. Additionally, an advantage of the symptom-based approach is improved readability and interpretability of error information for both human operators and machine learning models. Moreover, an advantage of distilling raw data into symptoms is the ability to more easily identify patterns and correlations across different services and error types.

In some implementations, the system uses a retrieval-augmented generation (RAG) prompt with a machine learning component to analyze errors and suggest mitigation strategies. Accordingly, an advantage of using RAG prompts is the ability to provide relevant contextual information to guide the machine learning component's response, improving diagnosis accuracy. Additionally, an advantage of this approach is its flexibility in handling novel error scenarios by combining learned knowledge with current context. Furthermore, an advantage of using machine learning for error analysis is the potential for continuous improvement over time as the system encounters and learns from new error patterns and successful mitigation strategies.

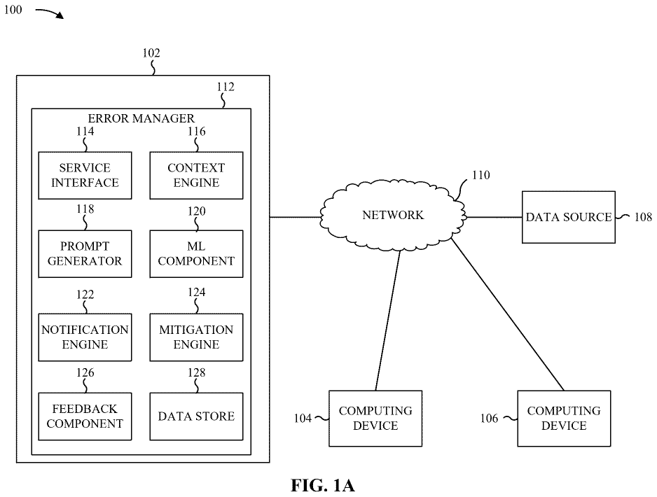

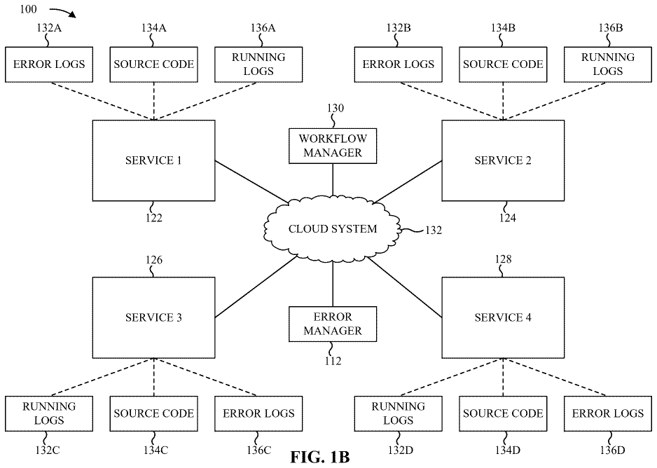

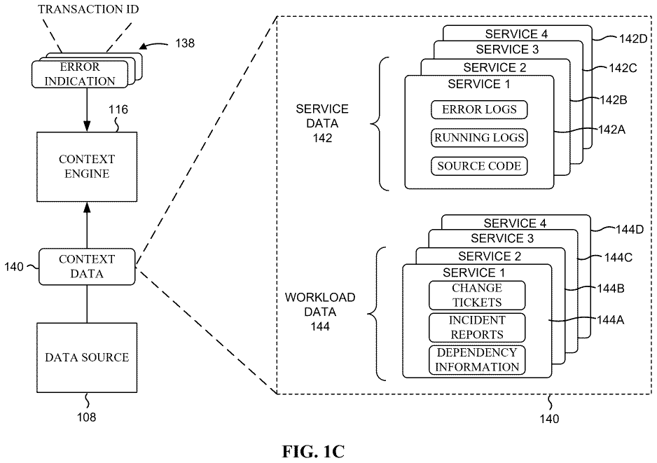

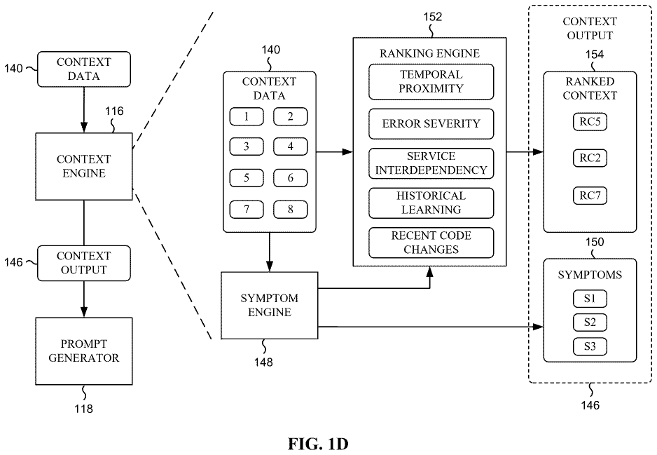

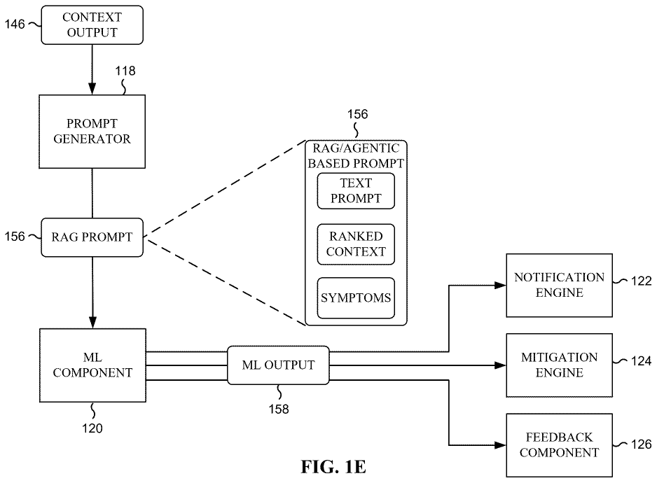

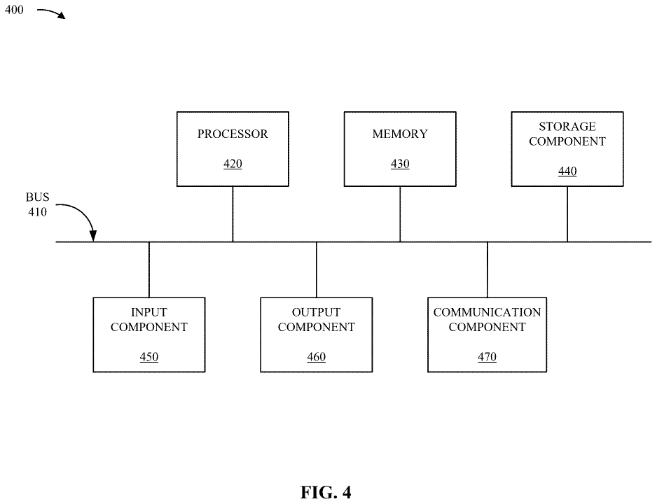

FIG. 1A is a block diagram of an example of a computing system 100 for context-driven error diagnosis and mitigation for cloud services. As shown, the computing system 100 includes computing devices 102, 104, and 106, a data source 108, a network 110, and an error manager 112. The computing devices 102, 104, and 106 may be any type of computing device capable of connecting to the network 110 and interacting with the cloud-based services. In some implementations, these devices may include personal computers, laptops, smartphones, tablets, or other internet-connected devices. One or more of the computing devices 102, 104, and 106 may be, be similar to, include, or be included in the device 400 of FIG. 4.

In some implementations, one or more of the computing devices 102, 104, and 106 may be used to implement a cloud environment with multiple services. These devices may serve as hosts for various cloud-based services, each potentially running multiple microservices or containerized applications. The cloud environment may be distributed across these devices, with different services running on different machines, allowing for scalability and load balancing. This distributed architecture may enable the cloud environment to handle a large number of concurrent operations and provide high availability for its services.

The computing devices 102, 104, and 106 may work in conjunction to form a cohesive cloud infrastructure. In some cases, these devices may be configured as part of a cluster, with workloads distributed among them based on resource availability and system demands. The cloud environment implemented across these devices may support various types of services, such as web applications, databases, storage solutions, and data processing pipelines. This multi-device setup may allow for redundancy and fault tolerance, as services can be replicated across multiple machines to ensure continuity in case of individual device failures. The computing devices 102, 104, and 106 may generate error indications or transaction data that can be used by the error manager 112 for diagnosis and mitigation purposes.

The error manager 112 includes a service interface 114, a context engine 116, a prompt generator 118, a machine learning (ML) component 120, a notification engine 122, a mitigation engine 124, a feedback component 126, and a data store 128. These components are configured to interact with each other to provide automated error diagnosis and mitigation in cloud-based environments. In some implementations, two or more of these components may be combined into a single component. In some implementations, one or more of these components may be split into multiple components. In some implementations, one or more of the service interface 114, the context engine 116, the prompt generator 118, the ML component 120, the notification engine 122, the mitigation engine 124, the feedback component 126, and the data store 128 may be implemented as software and/or hardware using any number of computing devices such as the computing device 102.

The data source 108 may be configured to store and provide various types of data relevant to the operation of the cloud-based services. In some implementations, the data source 108 may include databases, log files, code repositories, or other storage systems that contain information useful for error diagnosis and mitigation. The data source 108 may be accessed by the error manager 112 to obtain context data based on a transaction identifier (ID) associated with an error indication.

The data source 108 may be implemented as one or more computing devices (e.g., the computing device 102, 104 or 106), such as servers, dedicated storage appliances, or distributed storage systems. In some implementations, the data source 108 may be integrated with existing cloud infrastructure components, such as workload managers or individual services within the cloud environment. This integration may allow for efficient data collection and storage directly from the operational components of the cloud system. In some cases, the data source 108 may include a combination of centralized and distributed storage mechanisms. For example, high-frequency log data may be temporarily stored on local drives of individual services for rapid access, while aggregated historical data may be maintained in a centralized data warehouse. The data source 108 may implement data retention policies, archiving older data or compressing it for long-term storage while keeping recent, frequently accessed data readily available for quick retrieval by the error manager 112.

The data source 108 may support various data access methods and protocols to facilitate efficient retrieval of context data. In some implementations, it may provide APIs for real-time data streaming, allowing the error manager 112 to receive updates on system events as they occur. The data source 108 may implement indexing and search capabilities to enable rapid querying of large datasets based on transaction identifiers, timestamps, or other relevant criteria. This flexibility in data storage and access may enhance the error manager's ability to quickly gather comprehensive context for error diagnosis and mitigation.

The network 110 facilitates communication between the various components of the computing system 100. In some implementations, the network 110 may include local area networks (LANs), wide area networks (WANs), or the Internet. The network 110 may use various communication protocols to enable data transfer between the computing devices 102, 104, 106, the data source 108, and the error manager 112.

The error manager 112 may be configured to coordinate an error diagnosis and mitigation process associated with a cloud service. The error manager 112 includes a service interface 114, a context engine 116, a prompt generator 118, an ML component 120, a notification engine 122, a mitigation engine 124, and a feedback component 126. In some implementations, the service interface 114, the context engine 116, the prompt generator 118, the ML component 120, the notification engine 122, the mitigation engine 124, and the feedback component 126 may be implemented by one or more computing devices, e.g., the computing device 102. In some implementations, two or more of the service interface 114, the context engine 116, the prompt generator 118, the ML component 120, the notification engine 122, the mitigation engine 124, and the feedback component 126 may be combined into a single component.

The service interface 114 may be configured to interact with various cloud-based services, receiving error indications and transaction data. In some implementations, the service interface 114 may use standardized APIs or custom protocols to communicate with the services.

The service interface 114 may act as a communication bridge between the error manager 112 and the various cloud-based services within the computing system 100. In some implementations, the service interface 114 may utilize a combination of standardized APIs, custom protocols, and event-driven architectures to establish robust connections with diverse services. This flexibility in communication methods may allow the service interface 114 to adapt to different service architectures and data formats, ensuring comprehensive coverage across the cloud environment.

In some cases, the service interface 114 may implement real-time data streaming capabilities, enabling it to receive error indications and transaction data as they occur within the cloud services. The service interface 114 may also support batch processing of historical data, allowing for retrospective analysis of error patterns and system behavior. Additionally, the service interface 114 may include data transformation and normalization functions, converting service-specific data formats into a standardized structure that can be efficiently processed by other components of the error manager 112.

The service interface 114 may incorporate authentication and authorization mechanisms to ensure secure communication with the cloud services. In some implementations, it may support role-based access control, allowing fine-grained management of data access permissions. The service interface 114 may also include monitoring and logging capabilities, tracking its interactions with services and providing valuable metadata that can be used for auditing and performance optimization. Furthermore, the service interface 114 may be designed with scalability in mind, capable of handling increasing volumes of data and service connections as the cloud environment grows and evolves.

The context engine 116 may be configured to obtain context data from a plurality of data sources based on a transaction identifier (ID) associated with an error indication corresponding to an error associated with at least one cloud-based service. In some implementations, the context engine 116 may trace transactions across multiple services using the transaction ID to gather comprehensive context information. The context engine 116 may access running application logs, code repositories, and other data sources to extract relevant context data.

The context engine 116 may be designed to process and analyze large volumes of data from diverse sources to build a comprehensive contextual picture surrounding an error event. In some implementations, the context engine 116 may employ advanced data parsing and correlation techniques to extract relevant information from structured and unstructured data sources. This may include analyzing log files, database records, application metrics, and system configuration data to identify patterns and relationships that may be pertinent to the error under investigation.

In some cases, the context engine 116 may utilize machine learning algorithms to enhance its data processing capabilities. These algorithms may be trained on historical error data and successful resolution patterns, allowing the context engine 116 to more effectively identify relevant context information for new error scenarios. The context engine 116 may implement real-time data streaming and processing capabilities, enabling it to continuously update and refine the context information as new data becomes available during the error diagnosis process.

The context engine 116 may include mechanisms for data normalization and standardization across different services and data sources. This may involve transforming service-specific data formats into a common representation that can be more easily analyzed and correlated. In some implementations, the context engine 116 may maintain a knowledge base of known error patterns and their associated contextual indicators, which it can use to guide its data collection and analysis processes. The context engine 116 may also be capable of prioritizing and filtering context data based on relevance scores or predefined rules, helping to reduce noise and focus on the most pertinent information for error diagnosis and mitigation.

The prompt generator 118 may be configured to create a retrieval-augmented generation (RAG) prompt for a machine learning component. In some implementations, the prompt generator 118 may use the context output created by the context engine 116 to formulate a structured query that can be processed by the ML component 120. The prompt generator 118 may incorporate various elements of the context data and error symptoms into the RAG prompt to provide comprehensive information for analysis.

The prompt generator 118 may be designed to synthesize the contextual information gathered by the context engine 116 into a format that can be effectively processed by the ML component 120. In some implementations, the prompt generator 118 may employ natural language processing techniques to convert raw context data and error symptoms into a coherent and structured prompt. This process may involve selecting the most relevant pieces of information, organizing them in a logical sequence, and framing them in a way that guides the ML component 120 towards generating useful insights and mitigation strategies.

In some cases, the prompt generator 118 may utilize templates or dynamic prompt structures that can be adapted based on the specific type of error or the cloud services involved. These templates may include placeholders for key contextual elements such as error codes, affected services, recent system changes, and relevant log entries. The prompt generator 118 may also incorporate historical data on similar past errors and their resolutions, allowing the ML component 120 to leverage previous experiences in its analysis. In some implementations, the prompt generator 118 may include metadata about the current system state, such as overall system load, active user sessions, or ongoing maintenance activities, to provide a more comprehensive picture for error diagnosis.

The prompt generator 118 may implement feedback loops to continually refine its prompt generation process. In some implementations, the prompt generator 118 may analyze the effectiveness of previous prompts based on the quality of the ML component's output and subsequent error resolution success rates. This information may be used to adjust prompt structures, prioritize certain types of contextual information, or modify the language used in the prompts to improve the ML component's performance over time. The prompt generator 118 may support customization options, allowing system administrators to fine-tune the prompt generation process for specific use cases or to align with organizational best practices for error management.

The ML component 120 may be configured to process the RAG prompt and produce machine learning output indicative of a mitigation instruction associated with the error. A machine learning (ML) component refers to hardware and/or software capable of performing ML. ML is a subset of artificial intelligence (AI) that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, large language models (LLMs), and/or support vector machines (SVMs), among other examples.

Two common types of problems in ML are classification problems and regression problems. Classification problems, also referred to as categorization problems, aim at classifying items into one of several category values (for example, is this object an apple or an orange). Regression algorithms aim at quantifying some items (for example, by providing a value that is a real number). ML components utilize training data to find correlations among identified features that affect the outcome. For example, ML components utilize features for analyzing the data to generate assessments. A feature is an individual measurable property of a phenomenon being observed. The concept of a feature is related to that of an explanatory variable used in statistical techniques such as linear regression. Choosing informative, differentiating, and independent features is important for effective operation of the ML component in pattern recognition, classification, and regression. Features may be of different types, such as numeric features, strings, and graphs. ML components utilize the training data to find correlations among the identified features that affect the outcome or assessment. In some example embodiments, the training data includes labeled data, which is known data for one or more identified features and one or more outcomes. With the training data and the identified features, the ML component may be trained. The ML component appraises the value of the features as they correlate to the training data. The result of the training is the trained ML component. When the ML component is used to perform an assessment, new data is provided as an input to the trained ML component, and the ML component generates an assessment as output.

ML techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the ML technique used. For example, in a genetic or evolutionary algorithm, the values for the models that are most successful in predicting the desired outputs are used to develop values for models to use during the subsequent epoch, which may include random variation/mutation to provide additional data points.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau-the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

ML models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In the realm of natural language processing (NLP), ML training software can employ a learning paradigm focused on human preferences to better align pretrained and instruction-tuned generative language models with human values. This process involves the ML training software collecting extensive data, where each data point comprises a context, pairs of continuations of the context (generations), and a pairwise human preference indicating the superior generation. Subsequently, the ML training software learns to generate optimal continuations for a given context based on the collected data.

In some cases, the ML training software may employ reinforcement learning (RL), which is a method of training neural networks that may be used, for example, for training LLMs. Similar to human learning, RL trains neural networks through trial and error. Specifically, the neural network produces an output, receives feedback regarding this output, and then learns from the feedback. For instance, when finetuning a language model using reinforcement learning from human feedback (RLHF), the language model generates text and receives a score or reward from a human annotator, which reflects the quality of the text. The AI training software then employs RL to finetune the language model to generate outputs with high scores.

Reinforcement learning proves to be an advantageous and promising learning algorithm for neural networks because it allows learning from non-differentiable signals, which are incompatible with supervised learning. This capability enables the AI training software to learn from arbitrary feedback on a neural network's output. In the case of RLHF, the outputs generated by a language model can be scored according to any predefined principle. The AI training software then uses RL to learn from these scores, regardless of their definition.

Problems addressed via RL are typically structured in a consistent format. Specifically, an agent interacts with an environment, maintaining a state within this environment and producing actions that can alter the current state. As the agent interacts with the environment, it can receive both positive and negative rewards for its actions. The agent's objective is to maximize the rewards received, although not every action is associated with a reward. Rewards may have a long horizon, necessitating several correct, consecutive actions to generate any positive reward. In mathematical terms, RL may be described as a Markov decision process (MDP). An MDP includes states, actions, rewards, transitions, and a policy. States and actions have discrete values, while rewards are real numbers. In an MDP, a policy (referred to herein, interchangeably as a “policy model”) takes a state as input and outputs a probability distribution over possible actions. Given this output, a decision can be made for the action to be taken from a current state, and the transition is then a function that outputs the next state based upon the prior state and chosen action. Using these components, the agent can interact with the environment in an iterative fashion to generate a trained policy.

In some implementations, the ML component 120 may use advanced natural language processing techniques or specialized error diagnosis models to analyze the provided context and generate actionable insights. The ML component 120 may continually, periodically, or in response to a trigger event learn from new error patterns and successful mitigation strategies to improve its diagnostic capabilities over time.

The ML component 120 may be implemented in any number of various configurations. In some implementations, the ML component 120 may utilize an external large language model (LLM) hosted on cloud infrastructure, allowing for scalability and access to extensive computational resources. In other implementations, the ML component 120 may employ an internal LLM that is specifically tailored to the organization's cloud environment and error patterns, providing faster response times and enhanced data privacy. In some cases, the ML component 120 may leverage a combination of external and internal LLMs, utilizing the strengths of both approaches. For instance, an internal LLM may handle initial error analysis and context processing, while an external LLM may be consulted for more complex or novel error scenarios. The ML component 120 may also incorporate multiple specialized LLMs, each focused on different aspects of error diagnosis, such as code analysis, log interpretation, or historical pattern recognition. This multi-model approach may enable more comprehensive and accurate error diagnostics across diverse cloud services and infrastructure components.

Furthermore, the ML component 120 may incorporate agentic AI capabilities, allowing it to autonomously navigate through complex error scenarios and initiate appropriate mitigation actions. These AI agents may be designed to collaborate, with different agents specializing in various aspects of error diagnosis and mitigation. For example, one agent may focus on gathering relevant context data, another on analyzing code changes, and yet another on proposing mitigation strategies. The agentic AI system may adapt its behavior based on feedback from previous error resolution experiences, continuously improving its decision-making processes and mitigation effectiveness over time.

The notification engine 122 may be configured to transmit notifications based on the mitigation instructions produced by the ML component 120. In some implementations, the notification engine 122 may send alerts to system administrators, affected users, or other relevant parties about the detected error and suggested mitigation steps. The notification engine 122 may use various communication channels such as email, SMS, or in-application notifications to deliver these messages.

The notification engine 122 may be designed with customizable notification templates that can be tailored to different types of errors, severity levels, and recipient roles. These templates may include placeholders for dynamic content such as error details, affected services, and recommended actions, allowing for automated generation of informative and actionable notifications. In some implementations, the notification engine 122 may employ natural language generation techniques to create human-readable summaries of complex error scenarios, making the notifications more accessible to non-technical stakeholders.

The notification engine 122 may incorporate intelligent routing capabilities to ensure that notifications reach the most appropriate recipients based on factors such as the nature of the error, time of day, and on-call schedules. In some cases, the notification engine 122 may use machine learning algorithms to learn from past notification effectiveness and adjust its routing strategies accordingly. For instance, the notification engine 122 may track which team members or departments have been most successful in resolving specific types of errors and prioritize notifications to those individuals or groups for similar future incidents.

In some implementations, the notification engine 122 may provide interactive notification features that allow recipients to take immediate action directly from the notification interface. This may include options to acknowledge the error, escalate the issue, or initiate predefined mitigation scripts. The notification engine 122 may support bi-directional communication, enabling recipients to request additional information or provide feedback, which can be used to refine future notifications and improve the overall error management process. In some implementations, the notification engine 122 may integrate with external ticketing systems or incident management platforms, automatically creating and updating tickets based on the error notifications and subsequent actions taken.

The mitigation engine 124 may be configured to facilitate automated mitigation operations based on the mitigation instructions. In some implementations, the mitigation engine 124 may execute predefined scripts, roll back recent changes, or isolate problematic services to stabilize the system. The mitigation engine 124 may work in conjunction with the notification engine 122 to keep relevant parties informed about the automated actions being taken.

The mitigation engine 124 may be designed with a flexible architecture that allows it to adapt to various error scenarios and system configurations. In some implementations, the mitigation engine 124 may include a library of predefined mitigation strategies that can be applied to common error types. These strategies may range from simple actions like restarting a service or clearing a cache, to more complex operations such as load balancing adjustments or database query optimizations. The mitigation engine 124 may also have the capability to dynamically generate custom mitigation scripts based on the specific context of the error and the recommendations provided by the ML component 120.

In some cases, the mitigation engine 124 may implement a staged approach to error mitigation, starting with less invasive actions and progressively moving to more significant interventions if the error persists. This approach may help minimize potential disruptions to the system while attempting to resolve the issue. The mitigation engine 124 may also incorporate safety checks and rollback mechanisms to ensure that mitigation actions do not inadvertently cause further problems. For instance, before applying a mitigation strategy, the engine may create a snapshot of the current system state, allowing for quick restoration if the mitigation proves ineffective or causes unintended consequences.

The mitigation engine 124 may be equipped with monitoring capabilities to track the effectiveness of its actions in real-time. This may allow the engine to quickly assess whether a mitigation strategy is successful and adjust its approach accordingly. In some implementations, the mitigation engine 124 may leverage machine learning techniques to analyze the outcomes of past mitigation efforts and refine its decision-making process over time. This learning may enable the mitigation engine 124 to become more efficient and accurate in addressing various types of errors across different cloud services and infrastructure components.

The feedback component 126 may be configured to collect and process feedback on the effectiveness of the error diagnosis and mitigation actions. In some implementations, the feedback component 126 may gather input from system administrators or analyze system metrics to evaluate the success of mitigation strategies. This feedback may be used to refine the ML component's learning process and improve future error handling.

The feedback component 126 may be designed to operate as a continual improvement mechanism within the error management system. In some implementations, the feedback component 126 may collect data from various sources, including direct user feedback, system performance metrics, and the outcomes of mitigation actions. This comprehensive data collection approach may allow the feedback component 126 to build a holistic view of the error resolution process, capturing both quantitative and qualitative aspects of system performance and user satisfaction.

In some cases, the feedback component 126 may employ advanced analytics techniques to process and analyze the collected feedback data. These techniques may include sentiment analysis of user comments, trend analysis of error occurrence and resolution times, and correlation analysis between specific mitigation strategies and their effectiveness across different error types. The feedback component 126 may integrate with the ML component 120, providing a dataset that can be used to fine-tune the machine learning models and improve their predictive accuracy over time. This integration may create a dynamic learning loop, where the system's error diagnosis and mitigation capabilities continuously evolve based on real-world performance data.

The feedback component 126 may facilitate collaborative learning across different teams and departments within an organization. In some implementations, it may provide interfaces for sharing best practices, documenting successful resolution strategies, and highlighting recurring issues that may require broader systemic changes. The feedback component 126 may generate periodic reports or dashboards that summarize key performance indicators, emerging trends, and areas for improvement in the error management process. These insights may be valuable not only for technical teams but also for management in making informed decisions about resource allocation, training needs, and strategic initiatives to enhance overall system reliability and performance.

The data store 128 may be configured to store various types of data used by the error manager 112. In some implementations, the data store 128 may contain historical error logs, mitigation strategies, and learned patterns that can be referenced for future error diagnosis. The data store 128 may be continually, periodically, or in response to a trigger event updated with new information to enhance the system's diagnostic capabilities.

FIG. 1B is a block diagram of an example of a cloud computing environment implemented using the computing system of FIG. 1A. As shown, the cloud computing environment includes services such as Service 1 122, Service 2 124, Service 3 126, and Service 4 128. The services 122-128 may be managed via a workflow manager 130, all of which may be interconnected via a cloud system 132. Each service may include associated error logs (132A-D), source code (134A-D), and running application logs (136A-D).

In operation, when an error occurs in one of the cloud services, the error manager 112 may obtain context data from the relevant error logs, source code, and running application logs. The context engine 116 may create a set of error symptoms based on this context data, translating raw data into more concise and structured representations. In some implementations, the set of error symptoms may have a smaller data volume compared to the raw context data, improving processing efficiency.

The error manager 112 may perform transaction tracing to gather comprehensive context data across multiple interconnected services. In some implementations, the error manager 112 may utilize distributed tracing techniques to follow the path of a transaction as it moves through various components of the cloud system. This tracing may involve correlating log entries, timestamps, and unique identifiers across different services to reconstruct the complete lifecycle of a transaction. The error manager 112 may leverage existing tracing frameworks or implement custom tracing mechanisms tailored to the specific architecture of the cloud environment.

During the transaction tracing process, the error manager 112 may collect a wide range of data points, including service invocations, database queries, external API calls, and system resource utilization metrics. In some cases, the error manager 112 may inject trace context into service-to-service communications, allowing for seamless propagation of tracing information across service boundaries. This approach may enable the error manager 112 to identify performance bottlenecks, latency issues, and potential points of failure within the transaction flow. The collected trace data may be aggregated and analyzed to provide insights into the root cause of errors and to highlight areas for optimization.

The error manager 112 may also incorporate adaptive sampling techniques to balance the overhead of tracing with the need for comprehensive error diagnosis. In some implementations, the error manager 112 may dynamically adjust the sampling rate based on factors such as system load, error frequency, or the criticality of specific services. This adaptive approach may allow for more intensive tracing during periods of high error rates or when investigating particularly complex issues, while reducing the tracing overhead during normal operations. The error manager 112 may store and index the collected trace data in the data store 128, enabling rapid retrieval and analysis when diagnosing future errors or identifying recurring patterns in system behavior.

The error manager 112 may then create a RAG prompt using the context output and error symptoms. This prompt is sent to an ML component (e.g., the ML component 120), which analyzes the information and produces output indicating potential root causes and mitigation instructions. The notification engine 122 and mitigation engine 124 may then act on this output, sending notifications or performing automated mitigation actions as appropriate. The feedback component 126 may collect data on the effectiveness of these actions, which can be stored in the data store 128 for future reference. This feedback loop may facilitate continuous improvement of the error diagnosis and mitigation processes over time.

In this configuration, the computing system 100 efficiently orchestrates automated error diagnosis and mitigation for cloud services, ensuring rapid response to issues and minimizing service disruptions. The integration of context-driven analysis, machine learning, and automated mitigation allows for seamless handling of complex error scenarios, thereby enhancing the reliability and performance of cloud-based systems.

FIGS. 1C-1E are diagrams of examples of processes for context-driven error diagnosis and mitigation for cloud services. In some implementations, one or more aspects of the processes shown in FIGS. 1C-1E may be performed by the computing system 100 described in relation to FIG. 1A.

FIG. 1C illustrates a process for obtaining context data from a plurality of data sources based on a transaction identifier (ID) associated with an error indication corresponding to an error associated with at least one cloud-based service. The process includes a data source 108, which may be configured to store and provide various types of data relevant to the operation of cloud-based services. In some implementations, the data source 108 may include databases, log files, code repositories, or other storage systems that contain information useful for error diagnosis and mitigation.

The context engine 116 is configured to obtain context data from the data source 108. In some implementations, the context engine 116 may trace transactions across multiple services using the transaction ID to gather comprehensive context information. The context engine 116 may access running application logs, code repositories, and other data sources to extract relevant context data.

The error indications 138 represent the input to the context engine 116, which may include information about errors detected in the cloud-based services. These error indications may be generated by various components of the cloud system and may contain details such as error codes, timestamps, and affected service identifiers. The error indication 138 may trigger the context data collection operations by the context engine 116.

The context data 140 represents the output of the context engine 116, which includes the collected information relevant to the detected error. This context data may include log entries, code changes, configuration updates, and other pertinent information gathered from various sources within the cloud environment. The context data 140 may include service data 142 and workload data 144.

The service data 142 represents information specific to individual services within the cloud environment. This may include service data 142A, 142B, 142C, and 142D, corresponding to different services or microservices involved in the error scenario. Each service data block may contain information such as service configurations, dependencies, and operational metrics.

The service data 142 may encompass a wide range of information related to the individual services within the cloud environment. This data may include detailed configuration settings, such as environment variables, runtime parameters, and service-specific options that define how each service operates. In some implementations, the service data 142 may also contain information about service dependencies, including both internal dependencies on other microservices within the cloud environment and external dependencies on third-party APIs or services. This dependency information may be used for understanding the potential ripple effects of errors across interconnected services.

In some implementations, the service data 142 may include operational metrics and performance indicators specific to each service. These metrics may cover aspects such as response times, throughput, error rates, and resource utilization. In some cases, the service data 142 may incorporate historical performance data, allowing for trend analysis and the identification of recurring issues. The service data 142 may be dynamically updated to reflect the current state of each service, providing real-time insights into service behavior and potential anomalies that could be related to detected errors.

In some implementations, the service data 142 may include metadata about recent deployments, version information, and change logs associated with each service. This information may be used for correlating errors with recent code changes or configuration updates. The service data 142 may be structured in a way that facilitates easy comparison between different services, enabling the context engine 116 to identify patterns or discrepancies that could be relevant to the error diagnosis process. By aggregating and analyzing the service data 142 across multiple services, the error manager 112 may gain a comprehensive understanding of the overall system state and the specific conditions surrounding an error event.

The workload data 144 represents information about the current operational state and resource utilization of the cloud services. This may include workload data 144A, 144B, 144C, and 144D, corresponding to the workload information for different services or components within the cloud environment. Workload data may include metrics such as CPU usage, memory consumption, network traffic, and active user sessions.

The workload data 144 may provide a comprehensive view of the operational characteristics and resource utilization across different services within the cloud environment. This data may include real-time metrics such as CPU usage, memory consumption, disk I/O, network bandwidth utilization, and the number of active user sessions for each service. In some implementations, the workload data 144 may encompass higher-level performance indicators like request latency, throughput, and error rates, which can offer insights into the overall health and efficiency of each service.

The workload data 144 may be collected and updated at regular intervals, allowing the error manager 112 to track trends and identify anomalies that could be indicative of emerging issues. In some cases, the workload data 144 may include historical information, enabling the system to establish baseline performance metrics and detect deviations from normal operational patterns. This historical context may be useful when diagnosing intermittent or gradually developing errors that might not be immediately apparent from instantaneous measurements.

In some implementations, the workload data 144 may be correlated with the service data 142 to provide a more nuanced understanding of error conditions. For example, a sudden spike in CPU usage (reflected in the workload data) coupled with a recent code deployment (recorded in the service data) may help pinpoint the root cause of an error. The error manager 112 may use machine learning techniques to analyze patterns in the workload data 144, potentially identifying precursor conditions that often lead to errors and enabling proactive mitigation strategies.

In some implementations, the context engine 116 may analyze both the service data 142A-D and workload data 144A-D to process errors within the system. This comprehensive analysis may facilitate a more accurate diagnosis of the error's root cause by considering both the specific service configurations and the overall system state.

FIG. 1D illustrates a process for creating a set of error symptoms and context output based on the obtained context data. The process begins with the context engine 116 receiving context data 140, which may include the information gathered in the process illustrated in FIG. 1C.

The context engine 116 processes the context data 140 to generate context output 146. This context output may represent a refined and structured version of the raw context data, organized in a manner that facilitates further analysis and processing.

The symptom engine 148 is configured to create, based on the context data, a set of error symptoms associated with the error. In some implementations, the symptom engine 148 may translate raw data from the context data into the set of error symptoms. This translation process may involve extracting key information from logs, code changes, and other sources to create concise representations of the error's manifestations. The set of symptoms 150 represents the output of the symptom engine 148. In some implementations, the set of error symptoms may have a data volume that is smaller than a data volume of the raw data, improving processing efficiency. Each symptom in the set may encapsulate a specific aspect or indicator of the error, such as a particular error code, a performance anomaly, or a configuration mismatch.

The ranking engine 152 is configured to prioritize the context data and symptoms based on various ranking factors. In some implementations, the ranking engine 152 may consider factors such as temporal proximity to an incident, severity of the error, service interdependency, historical learning data, or occurrence of a code change event when prioritizing the information. The ranked context 154 represents the output of the ranking engine 152. This ranked context may include both the original context data and the derived symptoms, ordered according to their likely relevance or importance to the error diagnosis process.

The prompt generator 118 receives inputs from multiple sources-the context output 146, the set of symptoms 150, and the ranked context 154. The prompt generator 118 is configured to create a retrieval-augmented generation (RAG) prompt for a machine learning component based on these inputs.

FIG. 1E illustrates a process for generating and utilizing a RAG prompt for error diagnosis and mitigation. The process begins with the context output 146, which serves as input to the prompt generator 118.

The prompt generator 118 creates a RAG/agentic based prompt 156 based on the context output and other inputs described in FIG. 1D. In some implementations, the RAG/agentic based prompt may include a structured query incorporating various elements of the context data and error symptoms to provide comprehensive information for analysis. In some examples, the RAG/agentic based prompt may be built using agentic techniques for building prompts from ranked context and symptoms.

The prompt generator 118 may be designed to synthesize and structure the contextual information gathered from various sources into a format optimized for machine learning analysis. In some implementations, the prompt generator 118 may employ natural language processing techniques to convert the context output, set of symptoms, and ranked context into a coherent and structured RAG/agentic based prompt 156. This process may involve selecting the most relevant pieces of information, organizing them in a logical sequence, and framing them in a way that guides the ML component 120 towards generating useful insights and mitigation strategies for the detected error.

The RAG/agentic based prompt 156 may serve as a bridge between the collected context data and the machine learning analysis. In some cases, the RAG/agentic based prompt 156 may include multiple components, such as a description of the error, relevant contextual information, historical data on similar past errors, and specific questions or directives for the ML component 120. The prompt generator 118 may utilize templates or dynamic prompt structures that can be adapted based on the specific type of error, the cloud services involved, or the current system state. These templates may include placeholders for key contextual elements such as error codes, affected services, recent system changes, and relevant log entries, allowing for the generation of tailored prompts that focus the ML component's analysis on the most pertinent aspects of the error scenario.

The ML component 120 receives the RAG/agentic based prompt 156 and processes it to produce ML output 158. In some implementations, the machine learning component may include a large language model (LLM). The ML component 120 may be configured to infer at least one of a root cause of the error or an instruction for mitigating the error based on the information provided in the RAG/agentic based prompt.

The ML output 158 represents the result of the machine learning component's analysis. This output may include a diagnosis of the error and mitigation instructions associated with the error. In some implementations, the machine learning output may comprise a detailed explanation of the error's root cause and suggested steps for resolution.

The notification engine 122 may receive the ML output 158 and use it to generate and transmit notifications based on the mitigation instructions. In some implementations, the notification engine 122 may send alerts to system administrators, affected users, or other relevant parties about the detected error and suggested mitigation steps.

The mitigation engine 124 may also receive the ML output 158 and use it to facilitate automated mitigation operations based on the mitigation instructions. In some implementations, the mitigation engine 124 may execute predefined scripts, roll back recent changes, or isolate problematic services to stabilize the system.

The feedback component 126 may receive the ML output 158 and use it to collect and process feedback on the effectiveness of the error diagnosis and mitigation actions. In some implementations, the feedback component 126 may gather input from system administrators or analyze system metrics to evaluate the success of mitigation strategies.

In some implementations, the text prompt 59 may represent an additional input or output related to the error diagnosis and mitigation process. This text prompt may include human-readable descriptions or queries that can be used to supplement or interpret the machine-generated prompts and outputs.

The use of a RAG/agentic based prompt in conjunction with a machine learning component may facilitate more accurate and context-aware error diagnosis. By providing the ML component with relevant historical data, current system state, and derived symptoms, the system may be better equipped to identify subtle patterns or correlations that might not be apparent through traditional rule-based analysis methods.

In some implementations, the system may continually, periodically, or in response to a trigger event update its knowledge base and refine its diagnostic capabilities. This may involve incorporating new error patterns, successful mitigation strategies, and feedback from human operators into the machine learning models and ranking algorithms.

The modular nature of the system, with distinct components for context gathering, symptom generation, ranking, and machine learning analysis, may facilitate flexibility and scalability. In some implementations, individual components may be upgraded or replaced without requiring a complete overhaul of the error diagnosis and mitigation system, allowing for incremental improvements and adaptations to evolving cloud environments.

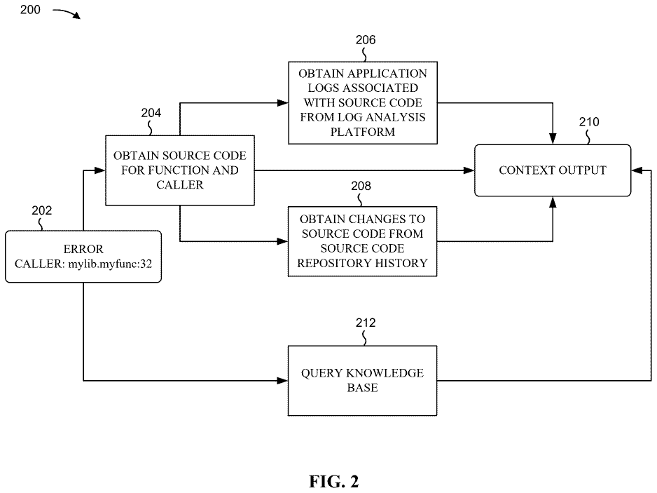

FIG. 2 is a diagram of an example of a process 200 for context-driven error diagnosis and mitigation for cloud services. In some implementations, one or more aspects of the process 200 may be performed by the computing system 100 described in relation to FIG. 1A.

The process 200 begins with an error indication 202 that includes caller information “mylib.myfunc:32”. In some implementations, the error indication 202 may be obtained based on a transaction identifier (ID) associated with an error corresponding to an error associated with at least one cloud-based service. The error indication 202 may be received by the error manager 112 through the service interface 114.

From the error indication 202, the process 200 branches into multiple parallel steps, illustrating the system's ability to gather context data from a plurality of data sources simultaneously. This parallel processing may facilitate efficient data collection and analysis, potentially reducing the time required for error diagnosis.

In step 204, the system obtains source code for a function and caller. This step may be performed by the context engine 116, which may be configured to retrieve relevant code snippets from a code repository or version control system. In some implementations, the context engine 116 may analyze the caller information provided in the error indication 202 to identify the specific function and its caller, then extract the corresponding source code.

Step 206 involves obtaining application logs associated with the source code from a log analysis platform. This step may be carried out by the context engine 116, which may be configured to interface with various logging systems or centralized log management platforms. In some implementations, the context engine 116 may use the transaction ID or other identifiers from the error indication 202 to filter and retrieve relevant log entries.

Step 208 involves obtaining changes to source code from a source code repository history. This step may also be performed by the context engine 116, which may be configured to interact with version control systems or code repositories. In some implementations, the context engine 116 may retrieve recent code changes or commits that could be related to the error, based on the function and caller information from the error indication 202.

The outputs from steps 204, 206, and 208 flow into a context output 210. This context output 210 may represent the aggregated context data obtained from the plurality of data sources. In some implementations, the context output 210 may be created by the context engine 116 based on the context data and a set of error symptoms associated with the error.

Additionally, the error indication 202 flows to step 212, which involves querying a knowledge base. This step may be performed by the context engine 116 or a specialized component designed for knowledge base interactions. In some implementations, the knowledge base may include historical root cause analysis outputs, known issues, or best practices for error resolution. The output from step 212 also flows into the context output 210, enriching the context with historical and expert knowledge.

The context output 210 serves as a comprehensive collection of relevant information for error diagnosis. In some implementations, the context output 210 may be used to create a set of error symptoms associated with the error. This translation from raw context data to a set of error symptoms may be performed by the symptom engine 148, which may be configured to distill complex information into more manageable and actionable insights.

In some implementations, the set of error symptoms may have a data volume that is smaller than a data volume of the raw context data, potentially improving processing efficiency. The symptom engine 148 may employ various techniques to translate raw data into error symptoms, such as pattern recognition, statistical analysis, or machine learning algorithms trained on historical error data.

The context output 210 may then be used to create a retrieval-augmented generation (RAG) prompt for a machine learning component. This step may be performed by the prompt generator 118, which may be configured to synthesize the context output and error symptoms into a structured query suitable for machine learning analysis. In some implementations, the RAG prompt may include elements of the context data, error symptoms, and specific questions or directives to guide the machine learning component's analysis. In some examples, the RAG prompt may include an RAG/agentic based prompt. For example, the RAG/agentic based prompt may be built using agentic techniques for building the prompt from ranked context and symptoms.

The process 200 may conclude with outputting the RAG prompt to the machine learning component, such as the ML component 120. This action may cause the machine learning component to produce machine learning output indicative of a mitigation instruction associated with the error. The machine learning component may analyze the provided context, symptoms, and historical data to infer the root cause of the error and suggest appropriate mitigation strategies.

In some implementations, the machine learning output may be provided to a notification engine, such as the notification engine 122, to cause the notification engine to transmit at least one notification based on the mitigation instruction. Additionally, the machine learning output may be sent to a mitigation engine, like the mitigation engine 124, to facilitate an automated mitigation operation based on the mitigation instruction.

The process 200 illustrates a comprehensive approach to error diagnosis and mitigation in cloud-based services. By gathering context from multiple sources, translating raw data into actionable symptoms, and leveraging machine learning for analysis, the system may facilitate rapid and accurate error resolution. The modular nature of the process, with distinct steps for data collection, symptom generation, and machine learning analysis, may allow for flexibility and scalability in addressing diverse error scenarios in complex cloud environments.

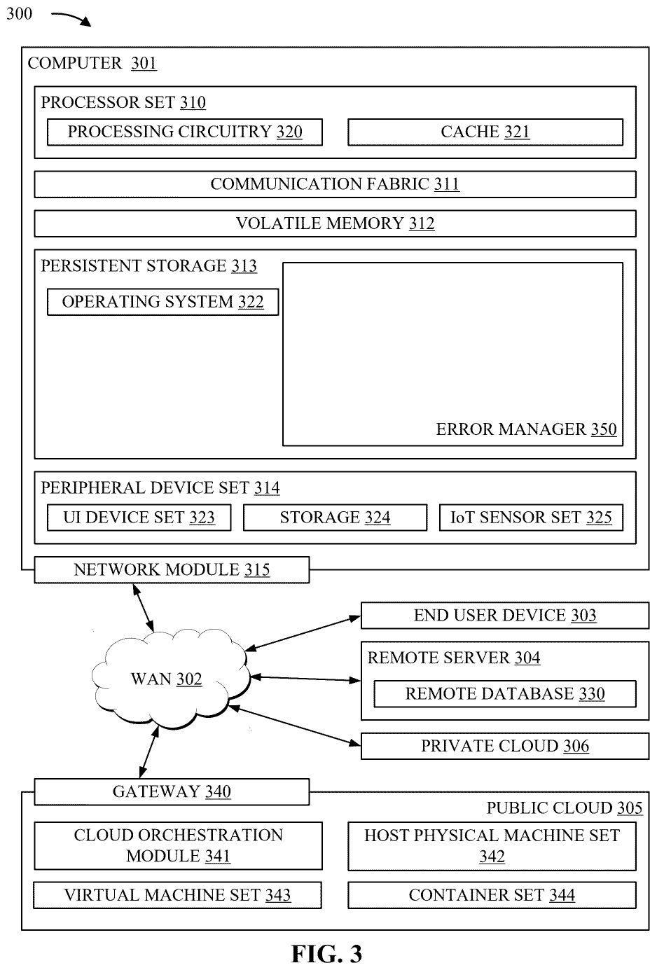

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The computing environment 300 contains an example of an environment for the execution of at least some of the computer code involved in performing the inventive methods, such as the error manager, shown in block 350. In addition to block 350, the computing environment 300 includes, for example, a computer 301, a wide area network (WAN) 302, an end user device (EUD) 303, a remote server 304, a public cloud 305, and a private cloud 306. In this embodiment, the computer 301 includes a processor set 310 (including processing circuitry 320 and a cache 321), a communication fabric 311, a volatile memory 312, persistent storage 313 (including an operating system 322 and a block 350, as identified above), a peripheral device set 314 (including a user interface (UI) device set 323, storage 324, and an Internet of Things (IoT) sensor set 325), and a network module 315. The remote server 304 includes a remote database 330. The public cloud 305 includes a gateway 340, a cloud orchestration module 341, a host physical machine set 342, a virtual machine set 343, and a container set 344.

The computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as a remote database 330. As is well understood in the art of computer technology, and depending upon the technology, performance of a computer-implemented method may be distributed among multiple computers and/or between multiple locations. On the other hand, in this presentation of the computing environment 300, detailed discussion is focused on a single computer, specifically the computer 301, to keep the presentation as simple as possible. The computer 301 may be located in a cloud, even though it is not shown in a cloud in FIG. 3. On the other hand, the computer 301 is not required to be in a cloud except to any extent as may be affirmatively indicated.

The processor set 310 includes one or more computer processors of any type now known or to be developed in the future. The processing circuitry 320 may be distributed over multiple packages, for example, multiple, coordinated integrated circuit chips. The processing circuitry 320 may implement multiple processor threads and/or multiple processor cores. The cache 321 is memory that is located in the processor chip package(s) and is typically used for data or code that should be available for rapid access by the threads or cores running on the processor set 310. Cache memories are typically organized into multiple levels depending upon relative proximity to the processing circuitry. Alternatively, some, or all, of the cache for the processor set may be located “off chip.” In some computing environments, the processor set 310 may be designed for working with qubits and performing quantum computing.

Computer readable program instructions are typically loaded onto the computer 301 to cause a series of operational steps to be performed by the processor set 310 of the computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 321 and the other storage media discussed below. The program instructions, and associated data, are accessed by the processor set 310 to control and direct performance of the inventive methods. In the computing environment 300, at least some of the instructions for performing the inventive methods may be stored in the block 350 in persistent storage 313.

The communication fabric 311 is the signal conduction path that allows the various components of the computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 312 is any type of volatile memory now known or to be developed in the future. Examples include dynamic type random access memory (RAM) or static type RAM. Typically, the volatile memory 312 is characterized by random access, but this is not required unless affirmatively indicated. In the computer 301, the volatile memory 312 is located in a single package and is internal to the computer 301, but, alternatively or additionally, the volatile memory 312 may be distributed over multiple packages and/or located externally with respect to the computer 301.

The persistent storage 313 is any form of non-volatile storage for computers that is now known or to be developed in the future. The non-volatility of this storage means that the stored data is maintained regardless of whether power is being supplied to the computer 301 and/or directly to the persistent storage 313. The persistent storage 313 may be a read only memory (ROM), but typically at least a portion of the persistent storage allows writing of data, deletion of data and re-writing of data. Some familiar forms of persistent storage include magnetic disks and solid state storage devices. The operating system 322 may take several forms, such as various known proprietary operating systems or open source Portable Operating System Interface-type operating systems that employ a kernel. The code included in block 350 typically includes at least some of the computer code involved in performing the inventive methods.

The peripheral device set 314 includes the set of peripheral devices of the computer 301. Data communication connections between the peripheral devices and the other components of the computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 323 may include components such as a display screen, speaker, microphone, wearable devices (such as goggles and smart watches), keyboard, mouse, printer, touchpad, game controllers, and haptic devices. The storage 324 is external storage, such as an external hard drive, or insertable storage, such as an SD card. The storage 324 may be persistent and/or volatile. In some embodiments, the storage 324 may take the form of a quantum computing storage device for storing data in the form of qubits. In embodiments where the computer 301 is required to have a large amount of storage (for example, where the computer 301 locally stores and manages a large database) then this storage may be provided by peripheral storage devices designed for storing very large amounts of data, such as a storage area network (SAN) that is shared by multiple, geographically distributed computers. The IoT sensor set 325 is made up of sensors that can be used in Internet of Things applications. For example, one sensor may be a thermometer and another sensor may be a motion detector.

The network module 315 is the collection of computer software, hardware, and firmware that allows the computer 301 to communicate with other computers through the WAN 302. The network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 315 are performed on the same physical hardware device. In other embodiments (for example, embodiments that utilize software-defined networking (SDN)), the control functions and the forwarding functions of the network module 315 are performed on physically separate devices, such that the control functions manage several different network hardware devices. Computer readable program instructions for performing the inventive methods can typically be downloaded to the computer 301 from an external computer or external storage device through a network adapter card or network interface included in the network module 315.

The WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 303 is any computer system that is used and controlled by an end user (for example, a customer of an enterprise that operates the computer 301) and may take any of the forms discussed above in connection with the computer 301. The EUD 303 typically receives helpful and useful data from the operations of computer 301. For example, in a hypothetical case where the computer 301 is designed to provide a recommendation to an end user, this recommendation would typically be communicated from the network module 315 of the computer 301 through the WAN 302 to the EUD 303. In this way, the EUD 303 can display, or otherwise present, the recommendation to an end user. In some embodiments, the EUD 303 may be a client device, such as thin client, heavy client, mainframe computer, desktop computer and so on.

The remote server 304 is any computer system that serves at least some data and/or functionality to the computer 301. The remote server 304 may be controlled and used by the same entity that operates the computer 301. The remote server 304 represents the machine(s) that collect and store helpful and useful data for use by other computers, such as the computer 301. For example, in a hypothetical case where the computer 301 is designed and programmed to provide a recommendation based on historical data, then this historical data may be provided to the computer 301 from the remote database 330 of the remote server 304.

The public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 305 is performed by the computer hardware and/or software of the cloud orchestration module 341. The computing resources provided by the public cloud 305 are typically implemented by virtual computing environments that run on various computers making up the computers of the host physical machine set 342, which is the universe of physical computers in and/or available to the public cloud 305. The virtual computing environments (VCEs) typically take the form of virtual machines from the virtual machine set 343 and/or containers from the container set 344. It is understood that these VCEs may be stored as images and may be transferred among and between the various physical machine hosts, either as images or after instantiation of the VCE. The cloud orchestration module 341 manages the transfer and storage of images, deploys new instantiations of VCEs and manages active instantiations of VCE deployments. The gateway 340 is the collection of computer software, hardware, and firmware that allows the public cloud 305 to communicate through the WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 306 is similar to the public cloud 305, except that the computing resources are only available for use by a single enterprise. While the private cloud 306 is depicted as being in communication with the WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 305 and the private cloud 306 are both part of a larger hybrid cloud.

FIG. 4 is a diagram of example components of a device 400, which may implement one or more components of the computing system 100. In some implementations, the device 400 may be, be similar to, include, or be included in the computer 301 shown in FIG. 3. The device 400 may be, be similar to, include, or be included in, an apparatus for performing one or more methods, processes, algorithms, operations, tasks, and/or techniques, as described herein. The device 400 may be, be similar to, include, or be included in, a computing device, a laptop, a workstation, a server device, or a personal computer, among other examples. As shown in FIG. 4, device 400 may include a bus 410 that interconnects various components or units, such as a processor 420, a memory 430, a storage component 440, an input component 450, an output component 460, and a communication component 470.

The processor 420 may be a central processing unit, such as a microprocessor, and may include single or multiple processors having single or multiple processing cores. The processor 420 may include another type of device, or multiple devices, configured for manipulating or processing information. For example, the processor 420 may include multiple processors interconnected in one or more manners, including hardwired or networked. The operations of the processor 420 may be distributed across multiple devices or units that can be coupled directly or across a local area or other suitable type of network. The processor 420 may include a cache, or cache memory, for local storage of operating data or instructions. The processor 420 is implemented in hardware, firmware, or a combination of hardware and software. In some implementations, the processor 420 includes one or more processors capable of being programmed to perform a function. In some implementations, the processor 420 may be, be similar to, include, or be included in processor set 310 shown in FIG. 3.

The memory 430 includes one or more memory components, which may each be volatile memory or non-volatile memory. The memory 430 may include non-transitory memory. The volatile memory can be random access memory (RAM) (e.g., a DRAM module, such as DDR SDRAM). The non-volatile memory of the memory 430 may be a disk drive, a solid state drive, flash memory, or phase-change memory. In some implementations, the memory 430 may be distributed across multiple devices. For example, the memory 430 may include network-based memory or memory in multiple clients or servers performing the operations of those multiple devices.

The memory 430 may include data for access by the processor 420. For example, the memory 430 may include executable instructions, application data, or an operating system, among other examples. The executable instructions may include one or more application programs, which may be loaded or copied, in whole or in part, from non-volatile memory to volatile memory to be executed by the processor 420. For example, the executable instructions may include instructions for performing techniques described in this disclosure. In some implementations, the application data may include functional programs, such as a computational programs, analytical programs, database programs, and so on. The operating system may be, for example, Microsoft Windows®, Mac OS X®, or Linux®; an operating system for a mobile device, such as a smartphone or tablet device; or an operating system for a non-mobile device, such as a mainframe computer.

The storage component 440 stores information and/or software related to the operation of the device 400. For example, the storage component 440 may include a hard disk drive, a magnetic disk drive, an optical disk drive, a solid state disk drive, a compact disc, a digital versatile disc, and/or another type of non-transitory computer-readable medium. The storage component 440 may be, be similar to, include, or be included in, the memory 430.

The input component 450 enables the device 400 to receive input, such as user input and/or sensed inputs. For example, the input component 450 may include a touch screen, a keyboard, a keypad, a mouse, a button, a microphone, a switch, a sensor, a global positioning system component, an accelerometer, a gyroscope, and/or an actuator. The output component 460 enables the device 400 to provide output, such as via a display, a speaker, and/or one or more light-emitting diodes. The communication component 470 enables the device 400 to communicate with other devices, such as via a wired connection and/or a wireless connection. For example, the communication component 470 may include a receiver, a transmitter, a transceiver, a modem, a network interface card, and/or an antenna.

The device 400 may perform one or more processes described herein. For example, a non-transitory computer-readable medium (e.g., the memory 430 and/or the storage component 440) may store a set of instructions (e.g., one or more instructions, code, software code, and/or program code) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

In the description herein, sentences describing a system, an apparatus, or a device as taking an action (such as performing, determining, initiating, receiving, calculating, deciding, computing, processing, etc.) are to be understood that some appropriate component of the system, apparatus, or device as taking the action. Such components may refer to hardware and/or software configured to take the action.

The terms “processor,” “processing circuitry,” “processor set,” or “controller” may refer to one or more processors. For example, reference to “a/the processor,” “a/the processor set,” or the like (in the singular) should be understood to refer to any one or more of the processors described in connection with FIGS. 3 and 4, such as a single processor or a combination of multiple different processors. Reference to “one or more processors” should be understood to refer to any one or more of the processors described in connection with FIGS. 3 and 4.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIGS. 3 and 4. For example, operation described as being performed by one or more memories can be performed by the same subset of the one or more memories or different subsets of the one or more memories. Additionally or alternatively, in some examples, one or more of the processors may be preconfigured to perform various functions or operations described herein without requiring configuration by software.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

An “engine” refers to a component constructed, programmed, configured, or otherwise adapted to perform a specific function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out. s used herein, the term “model” encompasses its plain and ordinary meaning. A model may include, among other things, one or more engines which receive an input and compute an output based on the input.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

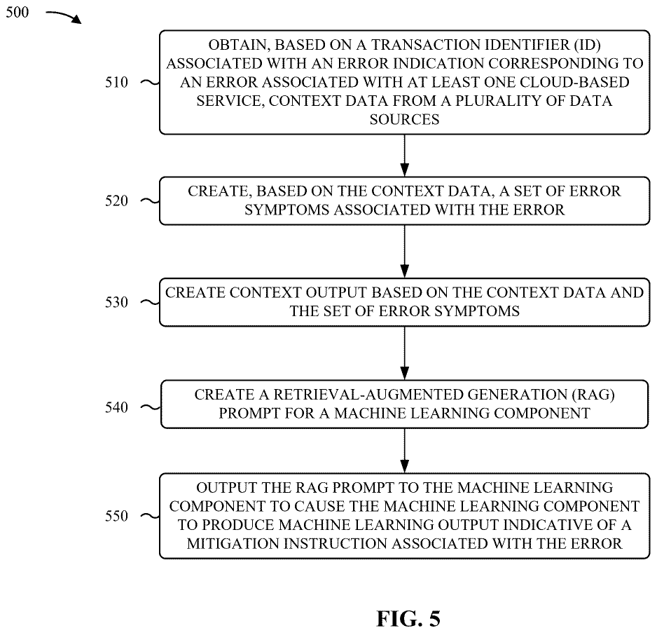

To further describe some implementations in greater detail, reference is next made to examples of techniques which may be performed by or using an AI system as described herein. FIG. 5 is a flowchart of an example of a technique 500 associated with context-driven error diagnosis and mitigation for cloud services. The technique 500 can be executed using computing devices, such as the systems, hardware, and software described with respect to FIGS. 1A-4. The technique 500 can be performed, for example, by executing a machine-readable program or other computer-executable instructions, such as routines, instructions, programs, or other code. The steps, or operations, of the technique 500, or another technique, method, process, or algorithm described in connection with the implementations disclosed herein can be implemented directly in hardware, firmware, software executed by hardware, circuitry, or a combination thereof.

For simplicity of explanation, the technique 500 is depicted and described herein as a series of steps or operations. However, the steps or operations of the technique 500 can occur in various orders and/or concurrently. Additionally, other steps or operations not presented and described herein may be used. Furthermore, not all illustrated steps or operations may be required to implement a technique in accordance with the disclosed subject matter.

At step 510, the technique 500 may include obtaining context data from a plurality of data sources based on a transaction identifier (ID) associated with an error indication corresponding to an error associated with at least one cloud-based service. In some implementations, this step may involve tracing transactions across multiple services using the transaction ID to gather comprehensive context information. The context data may be obtained from various sources such as running application logs, code repositories, issue tracking systems, workflow managers, or historical root cause analysis outputs.

In some implementations, step 510 may include obtaining running application logs associated with the cloud-based service or additional cloud-based services. The context engine may extract at least a portion of the context data from these running application logs. Additionally, step 510 may involve obtaining a database certificate indicative of a code change event corresponding to a set of source code associated with the cloud-based service or an additional cloud-based service. Based on this database certificate, the system may obtain code change data indicative of one or more code modifications corresponding to the code change event.

At step 520, the technique 500 may include creating a set of error symptoms associated with the error based on the context data. In some implementations, this step may involve translating raw data from the context data into the set of error symptoms. The translation process may include extracting information from running application logs, code repositories, and configuration changes. For instance, a large volume of log data may be distilled into a symptom like “500 authentication errors in US-East region within 5 minutes.”

In some implementations, the set of error symptoms created in step 520 may have a data volume that is smaller than the data volume of the raw data, potentially improving processing efficiency. The creation of error symptoms may involve extracting, from code change data indicative of one or more code modifications corresponding to a code change event, at least one of a code change or a configuration change. Based on the error, a representative error symptom indicative of the at least one code change or configuration change may be created.

At step 530, the technique 500 may include creating context output based on the context data and the set of error symptoms. In some implementations, this step may involve prioritizing the context data based on at least one ranking factor. The ranking factors may include temporal proximity to an incident, severity of the error, service interdependency, historical learning data, or occurrence of a code change event. This prioritization may help ensure that the most relevant information is given prominence in the context output.

The context output created in step 530 may be a refined and structured version of the raw context data, organized in a manner that facilitates further analysis and processing. In some implementations, the context output may include both the original context data and the derived symptoms, ordered according to their likely relevance or importance to the error diagnosis process. This structured output may facilitate more efficient and accurate error diagnosis in subsequent steps.

At step 540, the technique 500 may include creating a retrieval-augmented generation (RAG) prompt for a machine learning component. In some implementations, this step may involve using the context output and error symptoms to formulate a structured query that can be processed by the machine learning component. The RAG prompt may incorporate various elements of the context data and error symptoms to provide comprehensive information for analysis. In some examples, the RAG prompt may include an RAG/agentic based prompt. For example, the RAG/agentic based prompt may be built using agentic techniques for building prompts from ranked context and symptoms.

In some implementations, the creation of the RAG prompt in step 540 may involve employing natural language processing techniques to convert the context output, set of symptoms, and ranked context into a coherent and structured prompt. This process may involve selecting the most relevant pieces of information, organizing them in a logical sequence, and framing them in a way that guides the machine learning component towards generating useful insights and mitigation strategies for the detected error.

At step 550, the technique 500 may include outputting the RAG prompt to the machine learning component to cause the machine learning component to produce machine learning output indicative of a mitigation instruction associated with the error. In some implementations, the machine learning component may be a large language model (LLM). The machine learning component may be configured to infer at least one of a root cause of the error or an instruction for mitigating the error based on the information provided in the RAG prompt.

In some implementations, the machine learning output produced as a result of step 550 may comprise a detailed explanation of the error's root cause and suggested steps for resolution. This output may be provided to a notification engine to cause the notification engine to transmit at least one notification based on the mitigation instruction. Additionally, the machine learning output may be sent to a mitigation engine to facilitate an automated mitigation operation based on the mitigation instruction.

The technique 500 may facilitate rapid and accurate error resolution in complex cloud environments by gathering context from multiple sources, translating raw data into actionable symptoms, and leveraging machine learning for analysis. In some implementations, the modular nature of the process, with distinct steps for data collection, symptom generation, and machine learning analysis, may allow for flexibility and scalability in addressing diverse error scenarios in complex cloud environments.

In some implementations, the technique 500 may be enhanced with additional steps or variations. For example, the system may continually, periodically, or in response to a trigger event update its knowledge base and refine its diagnostic capabilities. This may involve incorporating new error patterns, successful mitigation strategies, and feedback from human operators into the machine learning models and ranking algorithms. Such ongoing refinement may improve the accuracy and efficiency of the error diagnosis and mitigation process over time.

According to an aspect of the disclosure, there is provided a computer-implemented method. The method includes obtaining context data from multiple data sources based on a transaction identifier associated with an error indication for an error in a cloud-based service. The method creates a set of error symptoms from the context data, creates context output based on the context data and error symptoms, creates a retrieval-augmented generation (RAG) prompt for a machine learning component, and outputs the RAG prompt to the machine learning component to produce output indicating a mitigation instruction for the error. This method improves error diagnosis and mitigation in complex cloud environments by automating the collection and analysis of relevant data across distributed systems. Additionally, the method enables faster and more accurate identification of error sources by leveraging machine learning and contextual information.

In embodiments, obtaining the context data can include tracing transactions across multiple services using the transaction ID. This has the technical effect of gathering comprehensive context information across interconnected microservices.

In embodiments, obtaining the context data can include getting running application logs for the cloud-based service or other services and extracting context data from those logs. This has the technical effect of capturing real-time operational data relevant to the error.

In embodiments, obtaining the context data can include getting a database certificate indicating a code change event for source code of a service and obtaining code change data for that event. This has the technical effect of identifying recent modifications that may have introduced errors.

In embodiments, creating the error symptoms can involve translating raw context data into the set of symptoms. This has the technical effect of distilling complex information into more manageable and actionable insights.

In embodiments, the set of error symptoms can have a smaller data volume than the raw data. This has the technical effect of improving processing efficiency by reducing the amount of data to analyze.

In embodiments, translating the raw data can include extracting code or configuration changes from code change data and creating a representative error symptom. This has the technical effect of highlighting specific modifications that may be related to the error.

In embodiments, creating the context output can involve prioritizing the context data based on ranking factors. This has the technical effect of focusing analysis on the most relevant information.

In embodiments, the ranking factors can include temporal proximity to an incident, error severity, service interdependency, historical learning data, or code change events. This has the technical effect of considering multiple dimensions of relevance when prioritizing context.

In embodiments, the machine learning component can infer a root cause of the error or instructions for mitigating it. This has the technical effect of providing actionable insights for error resolution.

In embodiments, the method can include providing the machine learning output to a notification engine to send notifications or to a mitigation engine to perform automated mitigation. This has the technical effect of enabling rapid response to detected errors.

According to an aspect of the disclosure, there is provided a computer program product with computer-readable storage media and program instructions. The instructions perform operations including obtaining context data from multiple data sources based on a transaction identifier for an error in a cloud-based service, creating error symptoms from the context data, creating context output, creating a RAG prompt for a machine learning component, and outputting the prompt to produce mitigation instructions. This product enables automated error diagnosis and mitigation in complex cloud environments. Additionally, it improves efficiency by leveraging machine learning for analysis of contextual information.

In embodiments, creating the error symptoms can involve translating raw context data into the set of symptoms. This has the technical effect of abstracting complex data into more actionable representations.

In embodiments, the error symptoms can have a smaller data volume than the raw data. This has the technical effect of reducing computational requirements for subsequent analysis.

In embodiments, the data sources can include running application logs, code repository history, issue tracking systems, workflow managers, or historical root cause analysis outputs. This has the technical effect of providing a comprehensive view of the system state and history.

According to an aspect of the disclosure, there is provided a computer system with a processor set, computer-readable storage media, and program instructions. The instructions cause the processor to perform operations including obtaining context data from multiple sources based on a transaction identifier for an error in a cloud-based service, creating error symptoms, creating context output, creating a RAG prompt for a machine learning component, and outputting the prompt to produce mitigation instructions. This system enables automated and efficient error diagnosis in complex cloud environments. Additionally, it leverages machine learning to provide actionable insights for error resolution.

In embodiments, the system can provide the machine learning output to a mitigation engine to perform automated mitigation. This has the technical effect of enabling rapid response to detected errors without manual intervention.

In embodiments, the machine learning component can be a large language model. This has the technical effect of leveraging advanced natural language processing capabilities for error analysis.

In embodiments, the machine learning output can include a diagnosis of the error. This has the technical effect of providing human-readable explanations of error causes to facilitate understanding and resolution.

In one implementation, a computer-implemented method includes obtaining context data from multiple data sources based on a transaction identifier associated with an error indication for an error in a cloud-based service. The method creates a set of error symptoms from the context data, creates context output based on the context data and error symptoms, creates a retrieval-augmented generation (RAG) prompt for a machine learning component, and outputs the RAG prompt to the machine learning component to produce output indicating a mitigation instruction for the error. The method also traces transactions across multiple services, including the cloud-based service, based on the transaction ID. This combination enables comprehensive error diagnosis across interconnected microservices by correlating data from multiple sources using the transaction ID. The tracing of transactions provides a holistic view of the error's propagation, facilitating more accurate root cause analysis.

In another implementation, the computer-implemented method includes obtaining context data, creating error symptoms, creating context output, creating a RAG prompt, and outputting the RAG prompt as described above. The method also traces transactions across multiple services and obtains running application logs associated with the cloud-based service or an additional cloud-based service, extracting at least a portion of the context data from these logs. This combination allows for a more comprehensive error diagnosis by incorporating both transaction tracing and detailed application log analysis. The inclusion of running application logs provides real-time operational context, enhancing the accuracy of error symptom generation and subsequent machine learning analysis.

In a further implementation, the computer-implemented method includes obtaining context data, creating error symptoms, creating context output, creating a RAG prompt, and outputting the RAG prompt as described above. The method also obtains running application logs associated with the cloud-based service or an additional cloud-based service and extracts at least a portion of the context data from these logs. This combination focuses on leveraging application logs for error diagnosis, providing detailed insights into the operational state of the services at the time of the error. The extraction of context data from logs enables the creation of more precise error symptoms, improving the overall accuracy of the error diagnosis process.

In another implementation, the computer-implemented method includes obtaining context data, creating error symptoms, creating context output, creating a RAG prompt, and outputting the RAG prompt as described above. The method also obtains a database certificate indicative of a code change event corresponding to a set of source code associated with the cloud-based service or an additional cloud-based service, and obtains code change data indicative of code modifications corresponding to the code change event. This combination enables the error diagnosis process to consider recent code changes as potential sources of errors. By incorporating code change information, the method can more effectively identify errors introduced by recent deployments or configuration updates, improving the accuracy of root cause analysis.

In yet another implementation, the computer-implemented method includes obtaining context data, creating error symptoms, creating context output, creating a RAG prompt, and outputting the RAG prompt as described above. The method also traces transactions across multiple services, obtains running application logs, extracts context data from the logs, obtains a database certificate indicative of a code change event, and obtains code change data. This comprehensive combination provides a holistic approach to error diagnosis by considering transaction flows, application logs, and recent code changes. The integration of these diverse data sources enables more accurate and context-rich error analysis, potentially reducing the time required to identify and resolve complex errors in distributed systems.

In a further implementation, the computer-implemented method includes obtaining context data, creating error symptoms, creating context output, creating a RAG prompt, and outputting the RAG prompt as described above. The method also translates raw data from the context data into the set of error symptoms. This combination enhances the efficiency of the error diagnosis process by abstracting complex raw data into more manageable and actionable error symptoms. The translation step reduces the cognitive load on both human operators and machine learning components, potentially accelerating the error resolution process.

In another implementation, the computer-implemented method includes obtaining context data, creating error symptoms by translating raw data, creating context output, creating a RAG prompt, and outputting the RAG prompt as described above. The method also extracts code or configuration changes from code change data indicative of code modifications corresponding to a code change event, and creates a representative error symptom indicative of the code or configuration change. This combination provides a more targeted approach to error diagnosis by focusing on recent code or configuration changes. By creating specific error symptoms related to these changes, the method can more effectively pinpoint potential sources of errors introduced by recent updates, improving the accuracy and efficiency of the diagnosis process.

In a further implementation, the computer-implemented method includes obtaining context data, creating error symptoms, creating context output, creating a RAG prompt, and outputting the RAG prompt as described above. The method also prioritizes the context data based on at least one ranking factor when creating the context output. This combination enhances the relevance of the information provided to the machine learning component by focusing on the most pertinent context data. The prioritization step can improve the accuracy of the machine learning analysis by ensuring that the most relevant information is given appropriate weight in the diagnosis process.

In another implementation, the computer-implemented method includes obtaining context data, creating error symptoms, creating context output, creating a RAG prompt, and outputting the RAG prompt as described above. The method also involves the machine learning component inferring at least one of a root cause of the error or an instruction for mitigating the error. This combination leverages the power of machine learning to provide actionable insights for error resolution. By inferring root causes or mitigation instructions, the method can significantly reduce the time and effort required for manual error analysis, potentially leading to faster error resolution and improved system reliability.

In yet another implementation, the computer-implemented method includes obtaining context data, creating error symptoms, creating context output, creating a RAG prompt, and outputting the RAG prompt as described above. The method also provides the machine learning output to a notification engine to cause the transmission of at least one notification based on the mitigation instruction, or provides the output to a mitigation engine to facilitate an automated mitigation operation. This combination enables rapid response to detected errors by automating the notification and mitigation processes. The integration with notification and mitigation engines can significantly reduce the time between error detection and resolution, potentially minimizing the impact of errors on system performance and user experience.

In one implementation, a computer program product includes instructions for obtaining context data, creating error symptoms, creating context output, creating a RAG prompt, and outputting the RAG prompt as described above. The product also includes instructions for extracting code or configuration changes from code change data indicative of code modifications corresponding to a code change event, and creating a representative error symptom indicative of the code or configuration change. This combination enables the software to provide more targeted error diagnosis by focusing on recent code or configuration changes. The creation of specific error symptoms related to these changes can improve the accuracy of the machine learning analysis, potentially leading to faster and more precise error resolution.

In another implementation, the computer program product includes instructions for obtaining context data, creating error symptoms, creating context output, creating a RAG prompt, and outputting the RAG prompt as described above. The product also specifies that the data sources include at least one of a running application log, a code repository history, an issue tracking system, a workflow manager, or a historical root cause analysis output. This combination enables the software to gather a comprehensive set of context data from diverse sources. By incorporating data from multiple systems and historical analyses, the product can provide a more holistic view of the error context, potentially improving the accuracy of the error diagnosis and the relevance of the mitigation instructions.

In one implementation, a computer system includes components for obtaining context data, creating error symptoms, creating context output, creating a RAG prompt, and outputting the RAG prompt as described above. The system also provides the machine learning output to a mitigation engine to facilitate an automated mitigation operation based on the mitigation instruction. This combination enables the system to not only diagnose errors but also take automated actions to resolve them. The integration with a mitigation engine can significantly reduce the time between error detection and resolution, potentially minimizing system downtime and improving overall reliability. The automated mitigation capability is particularly valuable in complex cloud environments where manual intervention may be time-consuming or impractical.

In one implementation, the error diagnosis and mitigation system effectively handles a complex error scenario in a cloud-based e-commerce platform. When a customer experiences a transaction failure during checkout, the system immediately traces the transaction across multiple microservices using the unique transaction ID. It gathers context data from the payment processing service, inventory management system, and user authentication module. The system then creates a set of error symptoms, such as “500 authentication errors in US-East region within 5 minutes” and “recent code deployment in inventory service”, distilling thousands of log entries into concise, actionable insights.

The context engine prioritizes this information based on temporal proximity to the incident and service interdependencies, creating a structured context output. This output is used to generate a RAG prompt for the machine learning component, which in this case is a large language model specialized in cloud service diagnostics. The LLM analyzes the prompt and infers that the root cause is likely a configuration mismatch introduced by the recent code deployment in the inventory service, which is causing cascading authentication failures.

Based on this analysis, the system automatically generates a mitigation instruction to roll back the inventory service to its previous stable version. This instruction is sent to the mitigation engine, which executes the rollback procedure without manual intervention. Simultaneously, the notification engine alerts the development team about the issue and the automated mitigation action taken. As a result, the e-commerce platform's downtime is minimized, and customer transactions resume normal operation within minutes, demonstrating the system's effectiveness in rapidly diagnosing and resolving complex, interdependent errors in a microservices architecture.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
obtaining, based on a transaction identifier (ID) associated with an error indication corresponding to an error associated with at least one cloud-based service, context data from a plurality of data sources;
creating, based on the context data, a set of error symptoms associated with the error;
creating context output based on the context data and the set of error symptoms;
creating a retrieval-augmented generation (RAG) prompt for a machine learning component; and
outputting the RAG prompt to the machine learning component to cause the machine learning component to produce machine learning output indicative of a mitigation instruction associated with the error.

2. The computer-implemented method of claim 1, wherein obtaining the context data comprises:
tracing transactions across a plurality of services, including the cloud-based service, based on the transaction ID.

3. The computer-implemented method of claim 1, wherein obtaining the context data comprises:
obtaining running application logs associated with at least one of the cloud-based service or an additional cloud-based service; and
extracting at least a portion of the context data from the running application logs.

4. The computer-implemented method of claim 1, wherein obtaining the context data comprises:
obtaining a database certificate indicative of a code change event corresponding to a set of source code associated with at least one of the cloud-based service or an additional cloud-based service; and
obtaining, based on the database certificate, code change data indicative of one or more code modifications corresponding to the code change event.

5. The computer-implemented method of claim 1, wherein creating the set of error symptoms comprises:
translating raw data from the context data into the set of error symptoms.

6. The computer-implemented method of claim 5, wherein the set of error symptoms includes a data volume that is smaller than a data volume of the raw data.

7. The computer-implemented method of claim 5, wherein translating the raw data comprises:
extracting, from code change data indicative of one or more code modifications corresponding to a code change event, at least one of a code change or a configuration change; and
creating, based on the error, a representative error symptom indicative of the at least one code change or configuration change.

8. The computer-implemented method of claim 1, wherein creating the context output comprises prioritizing the context data based on at least one ranking factor.

9. The computer-implemented method of claim 8, wherein the at least one ranking factor comprises at least one of a temporal proximity to an incident, a severity of the error, a service interdependency, historical learning data, or occurrence of a code change event.

10. The computer-implemented method of claim 1, further comprising:
inferring, by the machine learning component, at least one of a root cause of the error or an instruction for mitigating the error.

11. The computer-implemented method of claim 1, further comprising at least one of:
providing the machine learning output to a notification engine to cause the notification engine to transmit at least one notification based on the mitigation instruction; or
providing the machine learning output to a mitigation engine to cause the mitigation engine to facilitate an automated mitigation operation based on the mitigation instruction.

12. A computer program product, comprising:
one or more computer-readable storage media; and
program instructions stored on the one or more computer-readable storage media to perform operations, comprising:
obtaining, based on a transaction identifier (ID) associated with an error indication corresponding to an error associated with at least one cloud-based service, context data from a plurality of data sources;
creating, based on the context data, a set of error symptoms associated with the error;
creating context output based on the context data and the set of error symptoms;
creating a retrieval-augmented generation (RAG) prompt for a machine learning component; and
outputting the RAG prompt to the machine learning component to cause the machine learning component to produce machine learning output indicative of a mitigation instruction associated with the error.

13. The computer program product of claim 12, wherein creating the set of error symptoms comprises:
translating raw data from the context data into the set of error symptoms.

14. The computer program product of claim 13, wherein the set of error symptoms includes a data volume that is smaller than a data volume of the raw data.

15. The computer program product of claim 13, wherein translating the raw data comprises:
extracting, from code change data indicative of one or more code modifications corresponding to a code change event, at least one of a code change or a configuration change; and
creating, based on the error, a representative error symptom indicative of the at least one code change or configuration change.

16. The computer program product of claim 12, wherein the plurality of data sources includes at least one of a running application log, a code repository history, an issue tracking system, a workflow manager, or an historical root cause analysis output.

17. A computer system, comprising:
a processor set;
one or more computer-readable storage media; and
program instructions stored on the one or more computer-readable storage media to cause the processor set to perform operations comprising:
obtaining, based on a transaction identifier (ID) associated with an error indication corresponding to an error associated with at least one cloud-based service, context data from a plurality of data sources;
creating, based on the context data, a set of error symptoms associated with the error;
creating context output based on the context data and the set of error symptoms;
creating a retrieval-augmented generation (RAG) prompt for a machine learning component; and
outputting the RAG prompt to the machine learning component to cause the machine learning component to produce machine learning output indicative of a mitigation instruction associated with the error.

18. The computer system of claim 17, the operations further comprising:
providing the machine learning output to a mitigation engine to cause the mitigation engine to facilitate an automated mitigation operation based on the mitigation instruction.

19. The computer system of claim 17, wherein the machine learning component comprises a large language model (LLM).

20. The computer system of claim 17, wherein the machine learning output comprises a diagnosis of the error.
